(19) United States
(12) Patent Application Publication
(10) Pub. No.: US 2013/0093880 A1
(43) Pub. Date: Apr. 18, 2013

(54) Height Measurement Apparatus And Method

(71) Applicant: Matthew Paul Mellor, Cumbria (GB)

(72) Inventor: Matthew Paul Mellor, Cumbria (GB)

(21) Appl. No.: 13/411,201

(22) Filed: Mar. 2, 2012

(30) Foreign Application Priority Data
Oct. 12, 2011 (GB) 1117665.8

(51) Int. Cl. H04N 7/18

(52) U.S. Cl. 348/135; 348/E07.085

(57) ABSTRACT

A height measurement apparatus measures the height of an object visible in a plurality of non-synchronous aerial images captured from a moving platform. The apparatus includes an identification section adapted to identify an object in each of a pair of images comprising first and second images. A motion compensation section is adapted to calculate a motion-compensated location of the object in the second image. An effective-synchronous displacement calculation section is adapted to calculate the effective-synchronous displacement of the object as the displacement with respect to the background between the motion-compensated location of the object in the second image and the location of the object in the first image. A height calculation section is adapted to calculate the height of the object using the effective synchronous displacement, the altitude of the platform, and the distance travelled by the platform between capturing the pair of images.

### BACKGROUND OF THE INVENTION

1. Field of the Invention

There are many instances where it is desirable to be able to measure the height of an object from imagery. For example, in the field of environmental surveys it is desirable to be able to estimate the altitude of a flying bird from aerial imagery.

2. Description of the Related Art

It is well known that this can be achieved using two or more images of the same object taken from different view-points, a process often referred to as photogrammetry.

Photogrammetry works by looking at the change in image position of an object as the camera is moved. Objects of different heights will move differently, and if enough information about camera positions is available the height of each object can be calculated.

Photogrammetry is hard to apply to moving objects, because it is necessary to ensure that both images being compared are from exactly the same instant in time. If this is not the case, the height calculations can be subject to large errors.

### SUMMARY OF THE INVENTION

One aspect of the present invention provides a height measurement apparatus for measuring the height of an object visible in a plurality of non-synchronous aerial images captured from a moving platform, the apparatus comprising:

an identification section adapted to identify the object in each of a pair of images comprising first and second images;

a motion compensation section adapted to calculate the motion-compensated location of the object in the second image by correcting the actual location in the second image by the proper displacement of the object between the pair of images due to the object's own motion;

an effective-synchronous displacement calculation section adapted to calculate the effective-synchronous displacement of the object as the displacement with respect to the background between the motion-compensated location of the object in the second image and the location of the object in the first image; and

a height calculation section adapted to calculate the height of the object using the effective synchronous displacement, the altitude of the platform, and the distance travelled by the platform between capturing the pair of images.

Another aspect of the invention provides a method for measuring the height of an object visible in a plurality of non-synchronous aerial images captured from a moving platform, the method comprising:

identifying the object in each of a pair of images comprising first and second images;

calculating the motion-compensated location of the object in the second image by correcting the actual location in the second image by the proper displacement of the object between the pair of images due to the object's own motion;

calculating the effective-synchronous displacement of the object as the displacement with respect to the background between the motion-compensated location of the object in the second image and the location of the object in the first image; and

calculating the height of the object using the effective synchronous displacement, the altitude of the platform, and the distance travelled by the platform between capturing the pair of images.

The present invention enables the altitude of moving objects to be measured using un-synchronised images.

The images are referred to herein as ‘first and second images’, but it is understood that this does not imply any chronological sequence; i.e. the first image can be captured before the second image, or the first image can be captured after the second image.

### BRIEF DESCRIPTION OF THE DRAWINGS

Embodiments of the invention will now be described, by way of example only, with reference to the accompanying drawings in which:

FIG. 1 is a schematic illustration of a height measurement apparatus embodying the present invention;

FIGS. 2a and 2b illustrate image capture of a moving airborne object from a moving aerial platform;

FIGS. 3a and 3b are first and second non-synchronous images in which the object is visible;

FIG. 4 shows the second image on which constructions are shown for calculating the effective-synchronous displacement of the object according to an embodiment of the invention; and

FIG. 5 is a view schematically illustrating the calculation to obtain the height H of the object.

### DETAILED DESCRIPTION OF THE PREFERRED EMBODIMENTS

One embodiment of the invention comprises an imaging device, such as a digital video camera, attached to a moving platform, such as an aircraft. The imaging device captures a sequence of still images. The component of the motion of a flying object in the images normal to the motion of the imaging device is measured from the images and then the parallel component of the object motion is calculated from the orientation of the object and the normal motion. The parallel and normal motion components are then deducted from the observed displacement to derive the motion-compensated displacement. The height is then calculated using the motion compensated displacement, discussed in more detail below.

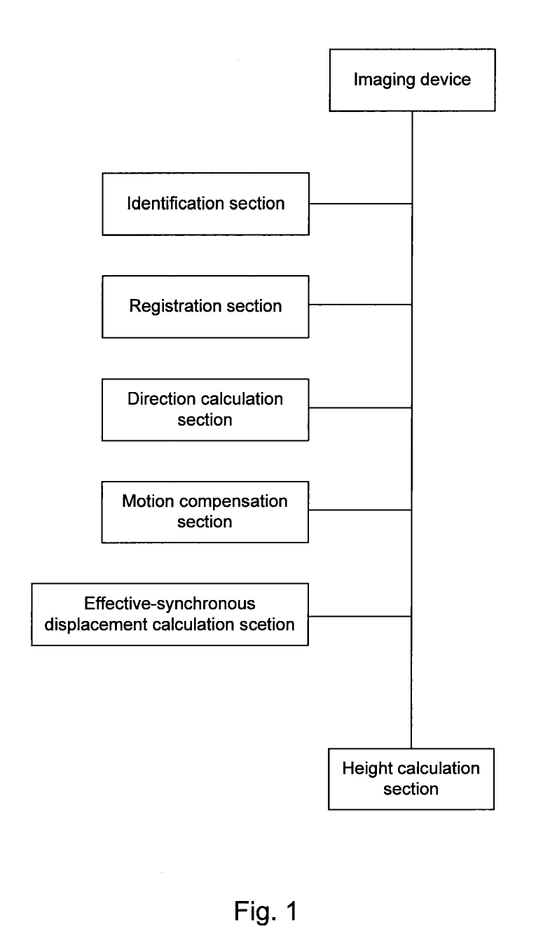

FIG. 1 shows schematically an embodiment of the height measurement apparatus comprising an imaging device, an identification section, a registration section, a direction calculation section, a motion compensation section, an effective-synchronous displacement calculation section and a height calculation section. The operation of the various sections is described below.

It is possible to implement each of the various items in FIG. 1 as dedicated hard-wired electronic circuits; however the various items do not have to be separate from each other, and could all be integrated onto a single electronic chip. Furthermore, the items can be embodied as a combination of hardware and software, and the software can be executed by any suitable general-purpose microprocessor, such that in one embodiment the apparatus can be a conventional personal computer (PC), such as a standard desktop or laptop computer with an attached monitor. The computer can be connected to an imaging device, such as a digital video camera, or can input a video file captured by a separate imaging device and transferred to the computer. Alternatively, the apparatus can be a dedicated device.

The invention can also be embodied as a computer program stored on any suitable computer-readable storage medium, such as a solid-state computer memory, a hard drive, or a removable disc-shaped medium in which information is stored magnetically, optically or magneto-optically. The computer program comprises computer-executable code that when executed on a computer system causes the computer system to perform a method embodying the invention.

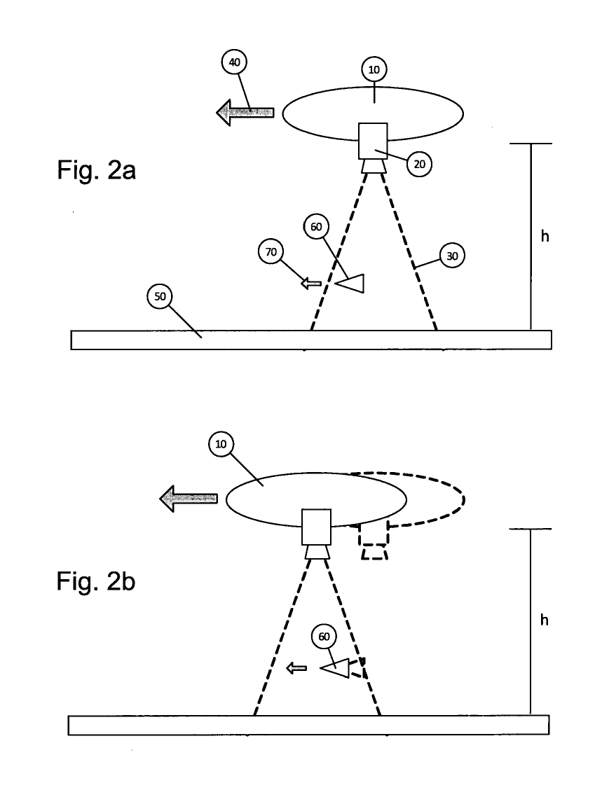

Referring to FIGS. 2a and 2b, the apparatus comprises a moving platform 10 e.g. a vehicle, such as an aeroplane, or satellite with an imaging device 20 that captures a sequence of still images. Preferably, the movement of the platform, indicated by the arrow 40 is constant and is known either by design or by measurement and is a pure translation, with no rotation component. Preferably, the motion of the platform is parallel to an approximately flat background 50, such as the ground or sea, at a fixed height h.

The imaging device 20 has a constant field of view 30, with respect to the moving platform 10. Sequential images are captured with the imaging device so that there is significant overlap between successive images. As a minimum, the overlap should be such that every point on the background is visible in at least 2 images. Preferably, each point in the background should appear in 10-20 images. This can be achieved, for example, using a video camera as the imaging device 20.

FIG. 2a shows an instant when one image is captured and FIG. 2b shows the situation at an instant when a later image is captured. Between these two instants, the platform 10 has moved according to the arrow 40, and the object has also moved as indicated by the arrow 70 (the proper motion of the object). Note that the arrows 40, 70 are not necessarily parallel. It is also assumed that in the time between these images, the heights of the platform 10 and the object 60 above the background 50 has not substantially changed. As can be seen in FIGS. 2a and 2b, the location of the object 60 in the field of view 30 of the imaging device 20 has changed between these two instants.

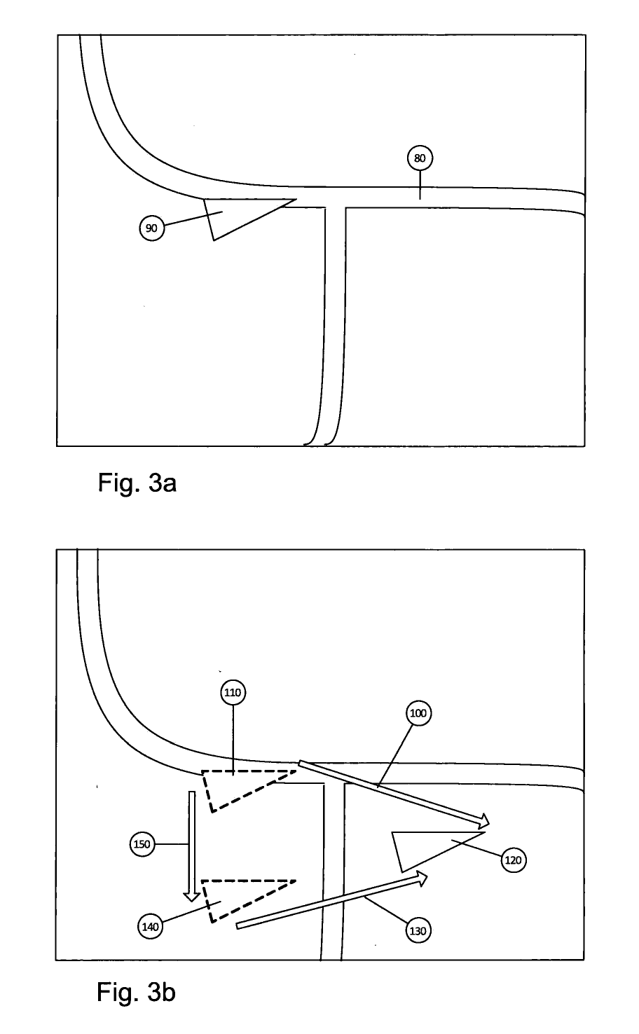

FIGS. 3a and 3b show exemplary images captured at the instants of FIGS. 2a and 2b respectively. The location of the object in the first image, FIG. 3a, is indicated at 90, and the location of the object in the second image, FIG. 3b, is indicated at 120. Background features are indicated in the images (shown at 80 in FIG. 3a). The translation or displacement of the background between the images can be calculated. This is a common task in many computer vision applications, where it is often referred to as image registration or image alignment. This is performed by the registration section, and there are many ways to achieve it. The simplest motion tracking method that can be used is cross-correlation combined with a bandpass pre-filter. The bandpass reduces high frequencies (noise) and very low frequencies (camera artefacts) and emphasises image features. Cross-correlation itself is a process in which every possible translation is evaluated using a similarity score comprising the sum of the multiple of the pixels of the current image with the pixels of the previous image. The best translation is the one that maximises this score. The resulting position in the second image (FIG. 3b) of the object in the first image (FIG. 3a) is shown at 110.

There is a measurable displacement 100 of the object relative to the background between the images. This can be calculated by subtracting the image coordinates of the original position 110 of the object with respect to the background from the coordinates of its position in the second image 120. Part of this displacement 100 is due to the motion 130 of the flying object and part of it is due to the motion 150 of the platform, as shown in FIG. 3b.

The displacement component 150 due to platform motion is parallel to the direction of platform motion. Had the flying object been stationary (i.e. hovering) or had the images been synchronous, the observed displacement would consist purely of this displacement 150 and the object would have appeared at a particular location in the image 140, determined by its height. From this displacement 150 it would be possible to calculate its height. The present invention enables the height to be calculated from un-synchronised images even when an object cannot be assumed to be stationary. To achieve this, the displacement 130 due to object motion is calculated and subtracted from the observed object displacement 100 to derive the effective-synchronous displacement 150 (also referred to as the stationary-equivalent displacement).

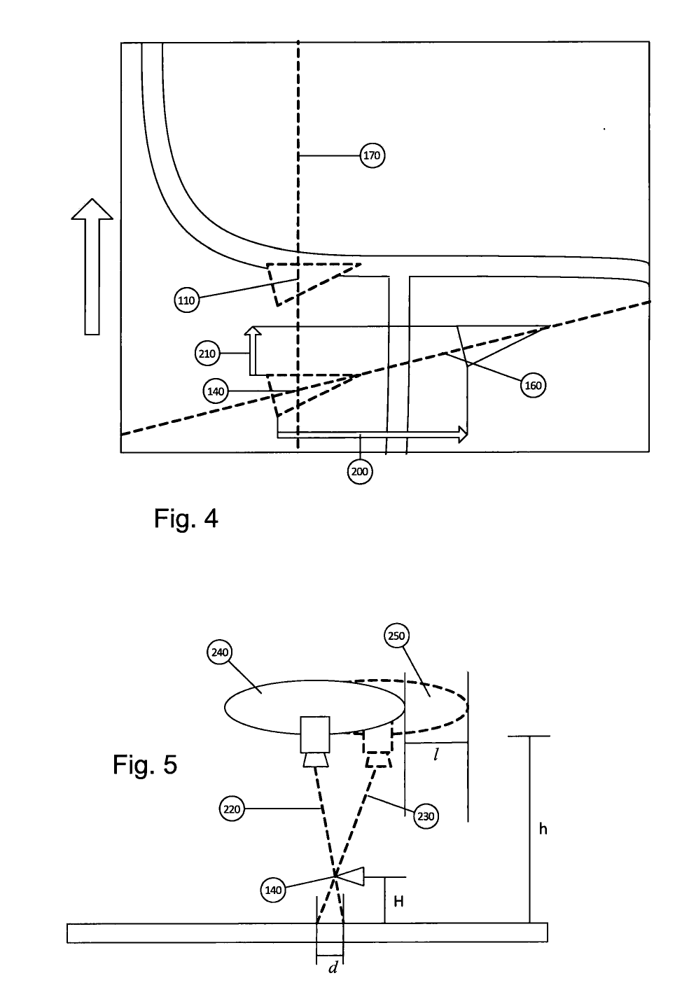

To obtain the object motion 130, the direction of motion of the object is first derived. This is possible for a large number of airborne objects, including natural objects, such as birds, and man-made objects, such as aircraft. Referring to FIG. 4, a line 160 is defined on the image passing through the front and back of the object, parallel to the inferred direction of travel. In the case where the object is a flying bird, for example, this line would pass through the centre of the head and tail. This line provides a constraint on the possible locations the flying object could have flown from during the interval between images. Equivalently, the line could be constructed in the first image to show the possible locations the object could have flown to, and the background of the second image could be brought into registration with the first image.

The direction of motion of the platform can be known from the direction of the displacement required to bring the images into registration, or may be know, for example from a fixed relationship between the orientation of the imaging device and moving platform. A second constraint line 170, shown in FIG. 4, is defined parallel to the direction of platform motion and passing through the centroid of the object as it would have appeared had it moved in exactly the same way as the background (i.e. if the images were synchronous and the object was at the same height as the background). This line 170 is the locus of displacements that could have been observed had the object been stationary. The intersection 140 of the two constraint lines 160, 170 is the point at which the object would have been observed had the second image been synchronous with the first. The displacement with respect to the background between this intersection point 140 and the location of the object in the first image 110 is termed the effective-synchronous displacement 150.

Although explained above in terms of calculating the intersection of the constraint lines, any other mathematically equivalent procedure can be used to obtain the motion-compensated location of the object. For example, referring to FIG. 4, the direction of motion of the imaging device 170 is known (for example from image registration or the set-up of the imaging device and aircraft). The component 200 of motion of the object normal (perpendicular) to the motion of the imaging device 170 can be obtained. From the orientation of the object (inferred to give the direction of proper motion of the object), the angle between the normal component of motion of the object and the direction of motion of the object, simple trigonometry can give the parallel component 210 of the motion of the object. Effectively, the vector motion of the object can be resolved into two components 200, 210, perpendicular and parallel to the motion of the platform. Subtracting these two components 200, 210 from the observed location 120 gives the motion compensated location of the object 140. Other equivalent vector manipulations can be performed. The motion could also be compensated forward in time from the image of FIG. 3a rather than backwards from FIG. 3b.

From the effective-synchronous displacement 150 the height of the object can be calculated as follows. Referring to FIG. 5, lines 220, 230 are defined at each of the two platform locations 240, 250 passing through the optical centre of the camera and through the effective synchronous object location 140. The lines cross at the object to form two similar triangles. The ratio of the width and height of each triangle must be constant, which provides a connection between the height of the flying object, H, the height h of the platform, the distance l travelled by the platform between images, and the effective synchronous displacement d. The height of the flying object H is given by multiplying the height of the moving platform h by the effective-synchronous displacement d and then dividing by the sum of the distance travelled by the platform l and the effective-synchronous displacement d. Mathematically, this can be expressed as:

$$H = \frac{hd}{l + d}$$

The absolute values of d and l do not need to be known, as long as they are expressed in the same units. For example, d and l could both be expressed in the number of pixels in the images (assuming square pixels); d being the effective synchronous displacement 150 in FIGS. 3b and 4, and l being the number of pixels to displace the background of FIG. 3a to bring it into registration with FIG. 3b.

A specific embodiment of the invention comprises a digital video camera mounted in or on the fuselage of an aircraft in a generally downward pointing configuration. Surveys are flown in which the aircraft flies in a series of straight lines over an area to be searched for flying objects. Flight height should be selected to be comfortably above the objects of interest; for example, 2000 ft (approx. 600 m) is a good choice for surveying seabirds. The image resolution is selected such that the objects to be observed are imaged in sufficient detail to accurately locate the front and back; for example, if the target objects are birds, a spatial resolution between 0.5 cm and 3 cm should be selected, dependent on the species. 2 cm is a reasonable choice for seabirds. The camera is mounted such that the vertical axis of the image plane is aligned with the direction of aircraft travel. The video frame rate is chosen so that every bird appears in at least 2 frames; preferably 10 or more frames. Video is captured during survey flights and then subsequently analysed on the ground, though it could be analysed in real-time. The identification section identifies the same bird appearing in multiple frames, for example using conventional feature detection techniques known from the field of computer vision. In each frame in which a bird appears, its head and tail are marked; this can be achieved manually by human observers, or alternatively can be implemented automatically by a direction calculation section using a template matching method or a neural network trained on a large set of manually marked images.

Pairs of images of containing the same bird viewed at different times are defined. The image registration section is used to align the backgrounds of the two images by moving the second image until it closely matches the first image according to some similarity criterion, such as maximising the normalised cross-correlation of pixel value. The motion compensation section uses the head and tail marks on the bird in the second image define the first constraint line. The centroid of the bird in the first image is defined as the mean of the head and tail marks of the bird. A vertical line passing through the centroid in the first image defines the second constraint line. The effective-synchronous displacement section then obtains the distance d measured in pixels between the centroid of the bird in the first image and the intersection of the two constraint lines. A GPS system can be used to measure aircraft velocity, which can give the distance l travelled by the platform between images if the time separation of the images is known. A radar altimeter can be used to measure aircraft altitude h. This gives the three values which are required to calculate the height H of the bird.

Where a flying object is visible in multiple images, multiple image pairs can be defined. This enables multiple estimates of the height to be obtained. The mean and variance of these heights can be calculated. The mean gives a more robust and precise estimate of the height than any of the individual estimates and it is preferable to use this value as the estimate of the object's height. The variance gives a quantification of the robustness of the height estimates. This can be used to discard poor height estimates, which may occur when the object is flying in almost the same direction as the moving platform or when accurately marking the front and rear of the object is difficult.

What is claimed is:

1. A height measurement apparatus for measuring the height of an object visible in a plurality of non-synchronous aerial images captured from a moving platform, the apparatus comprising:
an identification section adapted to identify the object in each of a pair of images comprising first and second images;
a motion compensation section adapted to calculate the motion-compensated location of the object in the second image by correcting the actual location in the second image by the proper displacement of the object between the pair of images due to the object's own motion;
an effective-synchronous displacement calculation section adapted to calculate the effective-synchronous displacement of the object as the displacement with respect to the background between the motion-compensated location of the object in the second image and the location of the object in the first image; and
a height calculation section adapted to calculate the height of the object using the effective synchronous displacement, the altitude of the platform, and the distance travelled by the platform between capturing the pair of images.

2. The apparatus according to claim 1, comprising a direction calculation section adapted to calculate the direction of motion of the object.

3. The apparatus according to claim 2, wherein the motion compensation section is adapted to calculate the motion-compensated location of the object by: determining the component of displacement of the object between the pair of images perpendicular to the direction of motion of the platform; calculating the proper displacement of the object using the calculated component of displacement and the calculated direction of motion of the object.

4. The apparatus according to claim 2, wherein the direction calculation section uses pattern recognition to identify the front and back of the object and calculates the direction of motion of the object as being directed along a line passing through the front and back of the object.

5. The apparatus according to claim 2, wherein the direction calculation section uses pattern recognition to identify an axis of symmetry of the object and calculates the direction of motion of the object as being directed along a line parallel to the axis of symmetry of the object.

6. The apparatus according to claim 2, wherein the motion-compensated location of the object is calculated to lie along a line passing through the location of the object in the second image parallel to the direction of motion of the object.

7. The apparatus according to claim 1, wherein the motion-compensated location of the object is calculated to lie along a line, passing through the location in the second image corresponding to the location of the object in the first image, parallel to the direction of motion of the platform.

8. The apparatus according to claim 1, further comprising a registration section adapted to calculate the relative displacement to bring the backgrounds of the pair of images into alignment.

9. The apparatus according to claim 8, wherein the direction of the displacement calculated by the registration section is used as the direction of motion of the platform.

10. The apparatus according to claim 8, wherein the magnitude of the displacement calculated by the registration section is used as the distance travelled by the platform between capturing the pair of images.

11. The apparatus according to claim 1, wherein the direction of motion of the platform in the images is set according to a known orientation of an imaging device, used to capture the images, with respect to the platform.

12. The apparatus according to claim 1, wherein the identification section is adapted to identify the object in multiple pairs of images, and the apparatus is arranged to calculate the height of the object multiple times using the multiple pairs of images.

13. The apparatus according to claim 1, wherein the object is an airborne bird.

14. A method for measuring the height of an object visible in a plurality of non-synchronous aerial images captured from a moving platform, the method comprising:
identifying the object in each of a pair of images comprising first and second images;
calculating the motion-compensated location of the object in the second image by correcting the actual location in the second image by the proper displacement of the object between the pair of images due to the object's own motion;
calculating the effective-synchronous displacement of the object as the displacement with respect to the background between the motion-compensated location of the object in the second image and the location of the object in the first image; and
calculating the height of the object using the effective synchronous displacement, the altitude of the platform, and the distance travelled by the platform between capturing the pair of images.

15. The method according to claim 14, further comprising calculating the direction of motion of the object.

16. The method according to claim 15, wherein the motion-compensated location of the object is calculated by: determining the component of displacement of the object between the pair of images perpendicular to the direction of motion of the platform; calculating the proper displacement of the object using the calculated component of displacement and the calculated direction of motion of the object.

17. The method according to claim 15, further comprising using pattern recognition to identify the front and back of the object and calculating the direction of motion of the object as being directed along a line passing through the front and back of the object.

18. The method according to claim 15, further comprising using pattern recognition to identify an axis of symmetry of the object and calculating the direction of motion of the object as being directed along a line parallel to the axis of symmetry of the object.

19. The method according to claim 15, wherein the motion-compensated location of the object is calculated to lie along a line passing through the location of the object in the second image parallel to the direction of motion of the object.

20. The method according to claim 14, wherein the motion-compensated location of the object is calculated to lie along a line, passing through the location in the second image corresponding to the location of the object in the first image, parallel to the direction of motion of the platform.

21. The method according to claim 14, further comprising applying registration to calculate the relative displacement to bring the backgrounds of the pair of images into alignment.

22. The method according to claim 21, further comprising using the direction of the displacement calculated by registration as the direction of motion of the platform.

23. The method according to claim 21, further comprising using the magnitude of the displacement calculated by registration as the distance travelled by the platform between capturing the pair of images.

24. The method according to claim 14, further comprising setting the direction of motion of the platform in the images according to a known orientation of an imaging device, used to capture the images, with respect to the platform.

25. The method according to claim 14, further comprising identifying the object in multiple pairs of images, and calculating the height of the object multiple times using the multiple pairs of images.

26. The method according to claim 14, wherein the object is an airborne bird.

27. A computer program comprising computer-executable code that when executed on a computer system causes the computer system to perform the method according to claim 14.

28. A computer-readable medium storing a computer program according to claim 27.
